(19) United States
(12) Patent Application Publication
(10) Pub. No.: US 2014/0287790 A1
(43) Pub. Date: Sep. 25, 2014

(54) COMMUNICATION SYSTEM AND RADIO WAVE MONITORING APPARATUS

(71) Applicant: BUFFALO INC., Nagoya-shi (JP)

(72) Inventors: Goki ICHIKAWA, Nagoya-shi (JP); Nagahiro Matsuura, Nagoya-shi (JP); Tomoaki Ohara, Nagoya-shi (JP); Daisuke Yamada, Nagoya-shi (JP)

(73) Assignee: BUFFALO INC., Nagoya-shi (JP)

(21) Appl. No.: 14/220,728

(22) Filed: Mar. 20, 2014

(30) Foreign Application Priority Data
Mar. 22, 2013 (JP) 2013-59658

(51) Int. Cl. H04W 72/04

(52) U.S. Cl. CPC H04W 72/04
USPC 455/509

(57) ABSTRACT

A radio wave monitoring apparatus that communicates with a wireless communication device which is separately provided from the radio wave monitoring apparatus and is configured to perform wireless communication via a channel selected from a plurality of channels; detects a specific radio wave at the plurality of channels; selects a channel for the wireless communication in response to a request from the wireless communication device and based on a result of the detecting; and sends channel information indicating the selected channel to the wireless communication device.

### CROSS-REFERENCE TO RELATED APPLICATIONS

The present application claims priority from Japanese Patent Application No. 2013-059658 filed on Mar. 22, 2013, the entirety of disclosure of which is hereby incorporated by reference into this application.

### TECHNICAL FIELD

The disclosure relates to communication.

### BACKGROUND ART

When radar wave is detected during wireless communication in a 5 GHz band, communication may be compelled to be interrupted for a predetermined time. Accordingly the configuration of providing a monitoring system separately from a communication system in a wireless communication device (access point) has been proposed (for example, JP 2010-278825A). The monitoring system monitors radar wave with respect to a plurality of channels, in parallel to communication by the communication system. In the case of changing a channel used for communication, when no radar wave has been detected for one minute at a monitored channel, this wireless communication device assumes that CAC (Channel Availability Check) has been performed and immediately starts wireless communication at the channel.

### SUMMARY

The problem of the above prior art is taking time and labor and increasing the cost for a change in monitoring operation, when such a change is needed accompanied with, for example, a modification of the rules and regulations involved in detection of radar wave, since the monitoring system is incorporated in the wireless communication device. Other needs include, for example, downsizing of a device, cost reduction, resource saving, easiness of manufacture and improved usability.

In order to solve at least part of the problems described above, the disclosure is implemented by the following aspect.

According to one aspect, there is provided a radio wave monitoring apparatus that communicates with a wireless communication device which is separately provided from the radio wave monitoring apparatus and is configured to perform wireless communication via a channel selected from a plurality of channels; detects a specific radio wave at the plurality of channels; selects a channel for the wireless communication in response to a request from the wireless communication device and based on a result of the detecting; and sends channel information indicating the selected channel to the wireless communication device.

### BRIEF DESCRIPTION OF DRAWINGS

FIG. 1 is a diagram illustrating the general configuration of a communication system;

FIG. 2 is a block diagram illustrating the internal configuration of a wireless communication device;

FIG. 3 is a block diagram illustrating the internal configuration of a radar wave monitoring apparatus;

FIG. 4 is block diagram illustrating the internal configuration of a receiver;

FIG. 5 is a flowchart showing a radar wave detection process;

FIG. 6 is a sequence diagram showing a channel change process (Embodiment 1);

FIG. 7 is a flowchart showing a channel selection process;

FIG. 8 is a sequence diagram showing a channel change process (Embodiment 2);

FIG. 9 is a diagram illustrating the general configuration of a communication system (Embodiment 3);

FIG. 10 is a block diagram illustrating the internal configuration of a wireless communication device (Embodiment 3);

FIG. 11 is a block diagram illustrating the internal configuration of a radar wave monitoring apparatus (Embodiment 3); and

FIG. 12 is a sequence diagram showing a channel change process (Embodiment 3).

### DESCRIPTION OF EMBODIMENTS

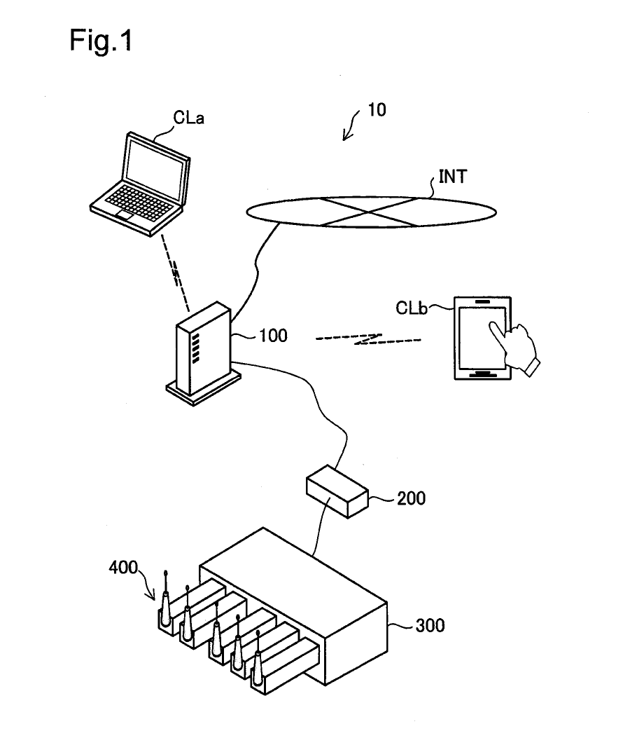

Embodiment 1 is described. FIG. 1 illustrates the general configuration of a communication system 10. In the illustrated configuration of FIG. 1, the communication system 10 includes a wireless communication device 100, a hub 200, a radar wave monitoring apparatus 300 and two client devices CLa and Clb. The wireless communication device 100 makes a wireless LAN. In the description below, the client device CLa and the client device CLb are called “client device CL” unless individual discrimination is required. The communication system 10 may include any arbitrary number of wireless communication devices 100 and any arbitrary number of client devices CL. The communication system 10 may include a wireless communication device performing WDS (Wireless Distribution System: inter-access point communication).

The wireless communication device 100 is a wireless LAN access point in conformity with the IEEE 802.11 standard. The wireless communication device 100 is connected to the Internet INT via a cable. The wireless communication device 100 also serves as a third layer router in the OSI reference model. The wireless communication device 100 relays wireless communication between the client devices CLa and CLb. The wireless communication device 100 is also capable of relaying wired communication.

The client device CLa is a personal computer equipped with a wireless communication interface in conformity with the IEEE 802.11 standard. The client device Clb is a smartphone equipped with a wireless communication interface in conformity with the IEEE 802.11 standard.

The radar wave monitoring apparatus 300 has five receivers 400. The five receivers 400 respectively receive radio waves in different frequency bands. These frequency bands are: “5.15 to 5.25 GHz (all channels (36ch to 48ch) in W52)”; “5.25 to 5.35 GHz (all channels (52ch to 64ch) in W53)”; “5.470 to 5.570 GHz (100ch to 112ch in W56)”; “5.570 to 5.650 GHz (116ch to 128ch in W56)”; and 5.650 to 5.725 GHz (132ch to 140ch in W56)”. The five receivers 400 receive the radio waves for the purpose of detecting radar wave and obtaining RSSIs of the respective channels. It should be noted that the channels belonging to W52 are excluded from the detection target of radar wave.

The hub 200 serves to make wired connection between the wireless communication device 100 and the radar wave monitoring apparatus 300 via the Ethernet (registered trademark).

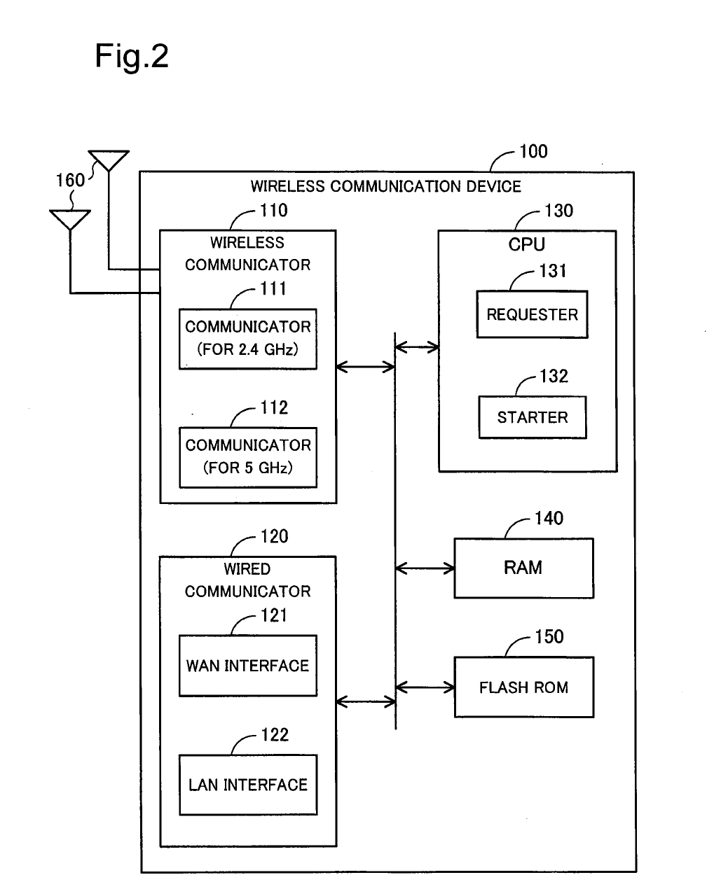

FIG. 2 is a block diagram illustrating the internal configuration of the wireless communication device 100. The wireless communication device 100 includes a wireless communicator 110, a wired communicator 120, a CPU 130, a RAM 140 and a flash ROM 150. These are interconnected via a bus.

The wireless communicator 110 includes a communicator 111, another communicator 112 and two antennas 160. The wireless communicator 110 performs demodulation of radio wave received via the antenna 160 and generation of data, as well as generation and modulation of radio wave to be sent via the antenna 160. The wireless communicator 110 employs MIMO (Multiple Input Multiple Output).

The communicator 111 makes communication using channels belonging to a 2.4 GHz band in conformity with the wireless LAN standard. The communicator 112 makes communication using channels belonging to a 5 GHz band in conformity with the wireless LAN standard. The communicator 112 has the function of detecting radar wave. The frequency bands as the detection target of radar wave by the communicator 112 are identical with those of the radar wave monitoring apparatus 300 and are frequency bands in W53 and W56.

The wired communicator 120 performs a process of shaping the waveform of a received signal and a process of extracting a MAC frame from the received signal. The wired communicator 120 includes a WAN interface 121 and a LAN interface 122. The WAN interface 121 is connected with a line on the Internet INT side. The LAN interface 122 is connected with the client device CL as the object of wired connection.

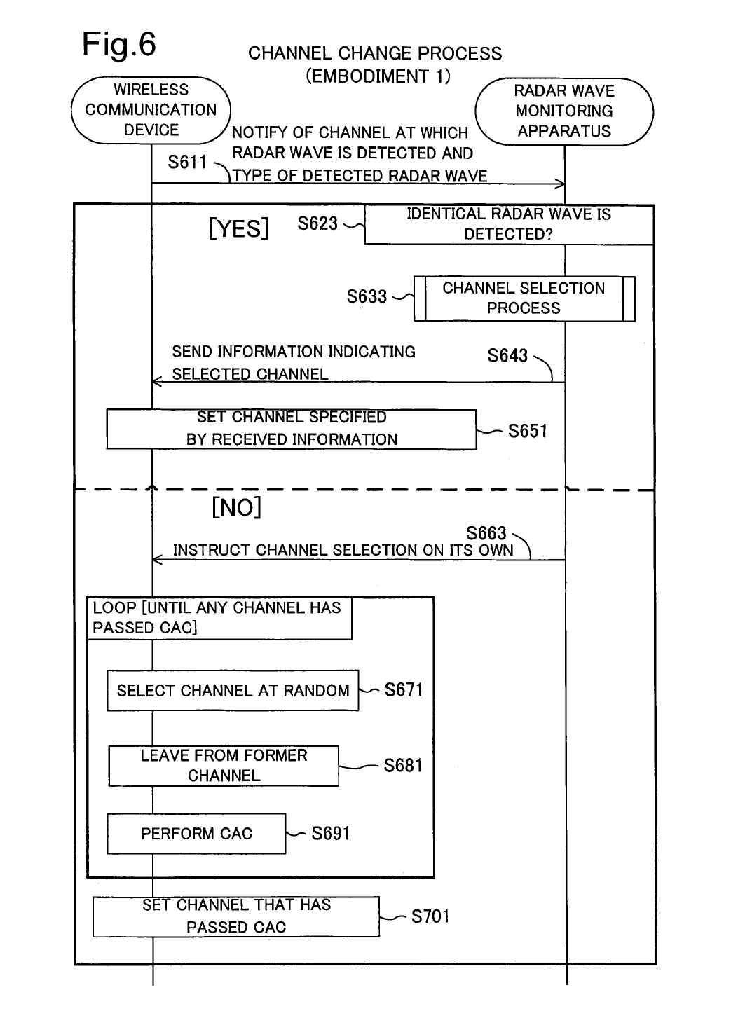

The CPU 130 loads and executes a program stored in the flash ROM 150 on the RAM 140 to serve as a requester 131 and a starter 132. The CPU 130 accordingly implements a channel change process (FIG. 6) described below. When the channel used for wireless communication is to be changed, the requester 131 of the CPU 130 requests the radar wave monitoring apparatus 300 to provide information on a channel to be used for wireless communication. The starter 132 starts wireless communication, based on information sent from the radar wave monitoring apparatus 300.

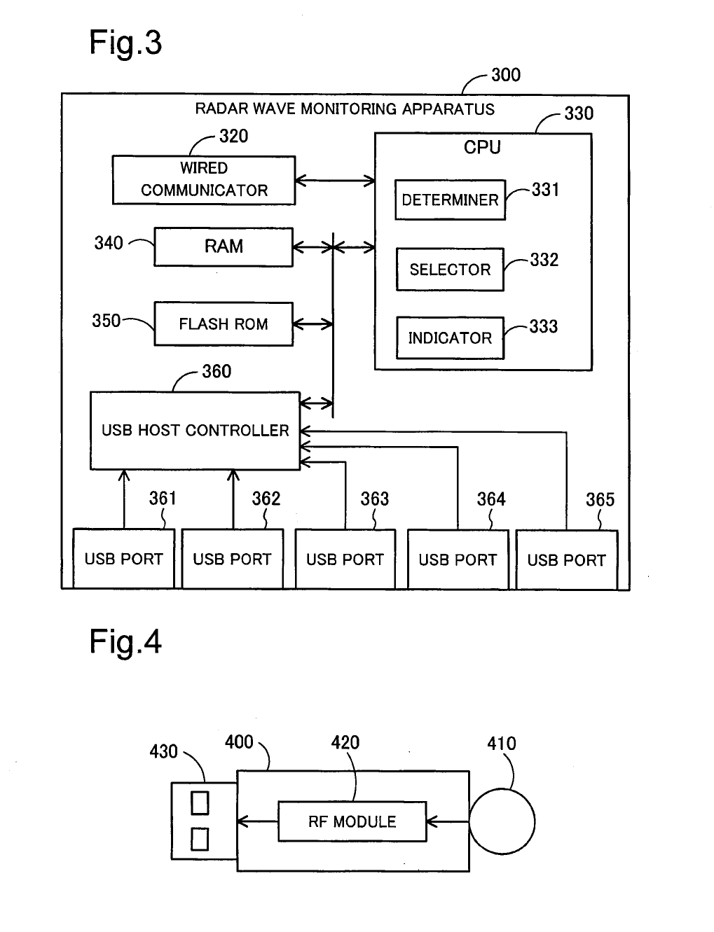

FIG. 3 is a block diagram illustrating the internal configuration of the radar wave monitoring apparatus 300. The radar wave monitoring apparatus 300 includes a wired communicator 320, a CPU 330, a RAM 340, a flash ROM 350, a USB host controller 360 and five USB ports 361, 362, 363, 364 and 365.

The USB ports 361 to 365 are respectively used for connection with the receivers 400. The USB host controller 360 is a controller configured to control communication between the receivers 400 and the CPU 330. The wired communicator 320 includes an Ethernet controller and a LAN port for wired connection with the hub 200.

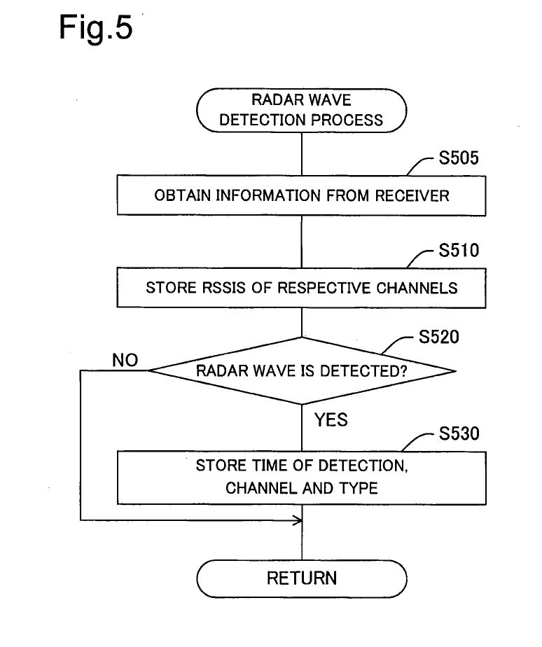

The CPU 330 loads and executes a program stored in the flash ROM 350 on the RAM 340 to serve as a determiner 331, a selector 332 and an indicator 333. The CPU 330 accordingly implements the channel change process (FIG. 6) described later. The determiner 331 of the CPU 330 checks the detection accuracy of radar wave by the radar wave monitoring apparatus 300. The selector 332 of the CPU 330 selects a channel to be used for wireless communication. The indicator 333 of the CPU 330 sends information regarding the channel selected by the selector 332 to the wireless communication device 100. The flash ROM 350 also stores a program for implementing a radar wave detection process (FIG. 5) described later.

FIG. 4 is a block diagram illustrating the internal configuration of the receiver 400. The receiver 400 includes an antenna 410, an RF module 420, a connector 430 and a device controller (not shown). The antenna 410 is a sleeve antenna. The RF module 420 performs a process of taking out data from the radio wave received by the antenna 410 by, for example, demodulation. The RF module 420 corresponds to one of the five frequency bands described above. The connector 430 is inserted into one of the USB ports 361 to 365 to serve as a communication path. The five receivers 400 have the same internal configuration, except a portion relating to the frequency band.

FIG. 5 is a flowchart showing a radar wave detection process. The radar wave detection process is continuously performed in a repeated manner by the CPU 330 included in the radar wave monitoring apparatus 300. On start of the radar wave detection process, the CPU 330 obtains information on the received radio wave from the receiver 400 (step S505). The CPU 330 subsequently stores the results of calculation of the RSSIs with regard to all the channels belonging to one of W52, W53 and W56 into the RAM 340, based on the information obtained at step S505 (step S510).

The CPU 330 then determines whether at least one of the five receivers 400 detects radar wave at any channel belonging to either W53 or W56 (step S520). When none of the five receivers 400 detects radar wave (step S520: NO), the CPU 330 repeats the series of processing from step S505 again.

When at least one of the five receivers 400 detects radar wave (step S520: YES), the CPU 330 stores the time when the radar wave is detected, the channel at which the radar wave is detected, and the type of the radar wave into the RAM 340 (step S530). After that, the CPU 330 repeats the series of processing from step S505 again. The CPU 330 identifies the type of the radar wave by comparing the pattern of the detected radar wave with patterns stored in advance in the flash ROM 350. The pattern herein includes a frequency pattern and a pulse pattern. The type of radar wave may be, for example, weather radar or ship radar. The type of radar wave may be specified by more detailed classification, for example, from which weather radar the radar wave is emitted and for what purpose, the radar wave is emitted, in addition to the classification like weather radar. When the pattern of the detected radar wave does not match any of the patterns stored in the flash ROM 350, the CPU 330 stores information indicating the pattern of the radar wave (for example, information showing the frequency pattern and the pulse pattern), as information regarding the type of radar wave which has not been stored in the flash ROM 350, into the RAM 340.

FIG. 6 is a sequence diagram showing a channel change process. The channel change process is triggered by detection of radar wave by the wireless communication device 100. The channel change process is performed by the radar wave monitoring apparatus 300 and one wireless communication device 100 which detects radar wave. The radar wave monitoring apparatus 300 is capable of performing the channel change process in combination with a plurality of wireless communication devices 100 in parallel.

In response to detection of radar wave by the communicator 112 of the wireless communicator 110, the CPU 130 of the wireless communication device 100 operates as the requester 131 to send detection information indicating the channel at which radar wave is detected and the type of the detected radar wave to the radar wave monitoring apparatus 300 (step S611). The CPU 130 identifies the type of radar wave in a similar manner to that of the radar wave monitoring apparatus 300.

The CPU 330 of the radar wave monitoring apparatus 300 operates as the determiner 331 to determine whether the radar wave specified by the detection information received from the wireless communication device 100 is detected at an almost equal time (step S623). The determiner 331 compares the detection information received from the wireless communication device 100 with the information stored in the radar wave detection process shown in FIG. 5, so as to determine whether the radar wave is detected at the almost equal time. This wording “at almost equal time” means that a time difference within a predetermined time period is allowed between the time when the detection information is received and the time stored in the radar wave detection process. The time difference is expected for both cases: receiving the detection information is earlier or detecting the radar wave is earlier. The predetermined time period is determined by taking into account a time required for arithmetic operations and communication. The purpose of such determination by the determiner 331 is to check whether the radar wave monitoring apparatus 300 has the radar wave detection accuracy comparable to or higher than that of the wireless communication device 100.

When the radar wave of the type specified by the detection information received from the wireless communication device 100 is received at the almost equal time (step S623: YES), the CPU 330 of the radar wave monitoring apparatus 300 operates as the selector 332 to perform a channel selection process (step S633).

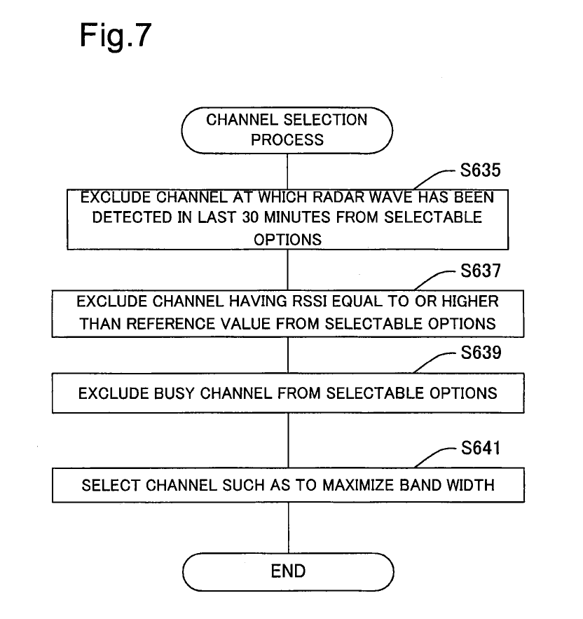

FIG. 7 is a flowchart showing the channel selection process. The selector 332 excludes any channel at which the radar wave monitoring apparatus 300 has detected radar wave in last 30 minutes from selectable options (step S635). The selector 332 subsequently excludes any channel having the RSSI equal to or higher than a reference value from the selectable options (step S637). The selector 333 then excludes any busy channel from the selectable options (step S639). It is determined whether a channel is busy, based on the working conditions of channels. The working conditions of channels include not only information regarding which channel is used by which wireless communication device 100 but information regarding which channels are used by adjacent wireless communication devices placed in independent networks from the radar wave monitoring apparatus 300. The working conditions are obtained based on information regularly received from the respective wireless communication devices 100 and the adjacent wireless communication devices. This information indicates which channel is used the wireless communication device 100 as the sender.

After excluding the respective channels from the selectable options (steps S635, S637 and S639), the selector 332 selects a channel in the 5 GHz band such as to maximize the band width (step S641). The band width of the channel selected by the selector 332 depends on the number of bonding channels. In Embodiment 1, bonding of 2, 4 or 8 channels is allowed according to the IEEE 802.11n/ac rules. When there are a plurality of combinations that allow for bonding a maximum number of channels, a channel is selected based on a predetermined condition. The predetermined condition may be, for example, selecting a combination of channels having the lowest RSSI or using only a vacant channel when a specific channel is busy in the state that channel bonding is allowed. When all the channels in the 5 GHz band are excluded, the selector 332 selects a channel in the 2.4 GHz band.

Referring back to the description of FIG. 6, after performing the channel selection process (step S633), the CPU 330 of the radar wave monitoring apparatus 300 operates as the indicator 333 to send channel information regarding the channel selected by the channel selection process (step S633) to the wireless communication device 100 (step S643).

When receiving the channel information from the radar wave monitoring apparatus 300, the CPU 130 of the wireless communication device 100 operates as the starter 132 to set the channel specified by the channel information from the radar wave monitoring apparatus 300 to a channel to be used (step S651). The starter 132 then starts wireless communication with the client device CL using the set channel. Setting by the starter 132 includes sending a CSA (Channel Switch Announcement) packet to the client device CL.

When it is not determined that the radar wave of the type specified by the detection information received from the wireless communication device 100 is received at the almost equal time (step S623: NO), on the other hand, the CPU 330 of the radar wave monitoring apparatus 300 sends instruction information to the wireless communication device 100 to instruct channel selection on its own (step S663).

When receiving the instruction information from the radar wave monitoring apparatus 300, the CPU 130 of the wireless communication device 100 selects one channel at random among the channels at which no radar wave has been detected in last 30 minutes (step S671). The CPU 130 subsequently releases from the formerly set channel and discontinues the use of the channel (step S681). This discontinuing step is performed to stop the use of a certain channel within 10 seconds when radar wave is detected at the certain channel. In order to achieve the foregoing, when neither channel information nor instruction information has been received even after elapse of 9 seconds since transmission of the detection information, the CPU 130 performs step S671 on the assumption that the instruction information is received.

After leaving from the former channel (step S681), the CPU 130 of the wireless communication device 100 performs CAC for 1 minute with respect to the channel selected at random (step S691). The CPU 130 repeats the series of steps of selecting a channel (step S671), leaving from the former channel (step S681) and performing CAC (step S691) until the channel passes CAC. Passing CAC means that no radar wave is detected as the result of CAC.

When a certain channel has passed CAC, the CPU 130 of the wireless communication device operates as the starter 132 to set the channel that has passed CAC to a channel to be used. The CPU 130 then starts wireless communication with the client device CL using the set channel (step S701).

Embodiment 1 described above has at least the following advantageous effects: (a) One radar wave monitoring apparatus 300 sends channel information to each of the plurality of wireless communication devices 100. Compared with the configuration that each of the plurality of wireless communication devices 100 is provided with the function of monitoring radar wave at each channel without establishment of connection, this reduces the manufacturing cost and the cost involved in modification of rules and regulations. (b) The radar wave monitoring apparatus 300 uses a plurality of receivers 400 respectively receiving narrow frequency bands. This reduces the cost, compared with the configuration using only one receiver receiving a wide frequency band. (c) The radar wave monitoring apparatus 300 which does not have the radar wave detection accuracy comparable to that of the wireless communication device 100 does not send channel information. This reduces the possibility that CAC is omitted when it is not assumable that CAC has been performed. (d) It is highly probable that a channel with detection of no radar wave has been checked in advance. This avoids disruption of communication by CAC and reduces the possibility of communication interruption.

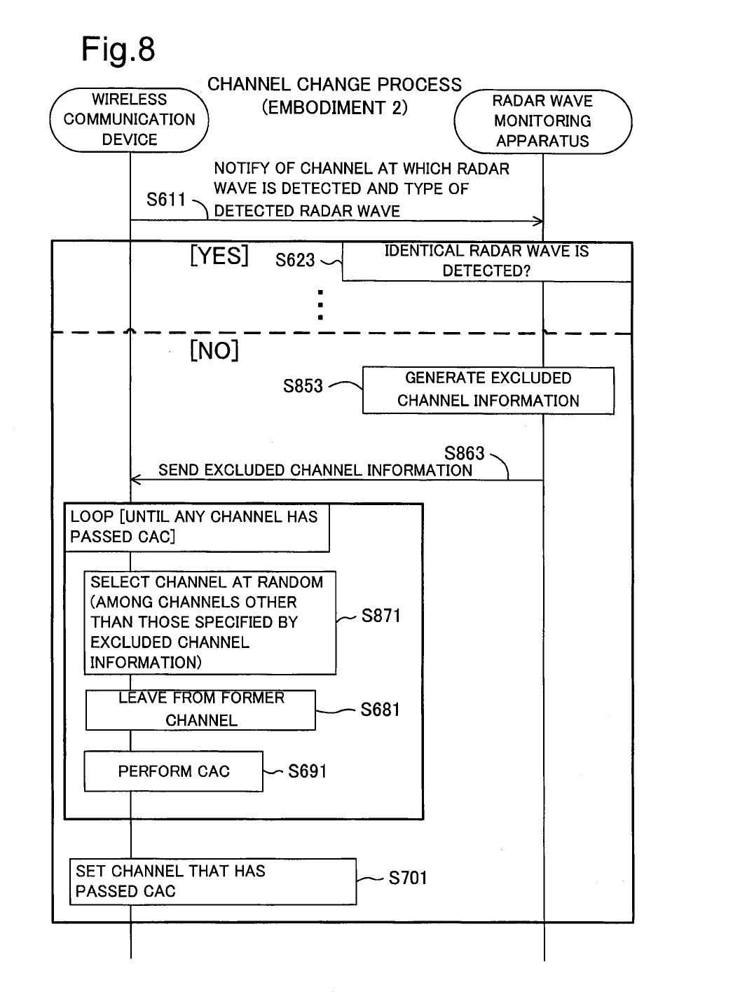

Embodiment 2 is described. Embodiment 2 differs from Embodiment 1 by part of the channel change process. FIG. 8 is a sequence diagram showing a channel change process according to Embodiment 2. The processing flow of Embodiment 2 does not differ from the processing flow of Embodiment 1 when the answer is YES at step S623 and is not illustrated in FIG. 8. Steps S611 and S623 are also identical with those of Embodiment 1 and are not described here.

According to Embodiment 2, when the answer is NO at step S623, the CPU 330 of the radar wave monitoring apparatus 300 generates excluded channel information (step S853). The excluded channel information is information indicating channels undesired for selection. The CPU 330 generates the excluded channel information, based on information accumulated by the radar wave detection process. For example, the CPU 330 includes any channel at which radar wave has been detected, any channel which is busy and any channel which is being used by a large number of wireless communication devices in the excluded channel information. After generating the excluded channel information (step S853), the CPU 330 sends the generated excluded channel information to the wireless communication device 100 (step S863).

When receiving the excluded channel information, the CPU 130 of the wireless communication device 100 selects a channel at random among the channels other than those specified by the excluded channel information (step S871). Steps S681, S691 and S701 are identical with those of Embodiment 1 and are not described here.

When the wireless communication device 100 selects a channel on its own, Embodiment 2 does not select a channel completely at random but excludes undesired channels for selection, so that it is more likely to select a desired channel for selection. The desired channels for selection include, for example, any channel at which no radar wave has been detected, any channel which is not so busy and any channel which is being used by a less number of wireless communication devices.

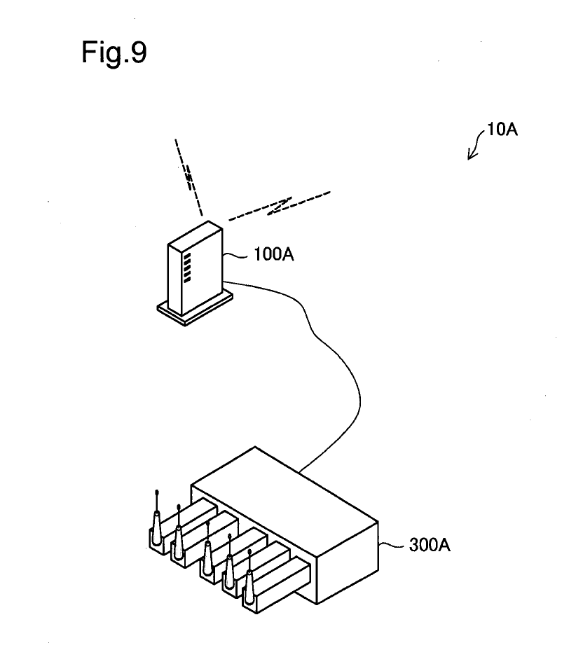

FIG. 9 is a diagram illustrating the general configuration of a communication system 10A according to Embodiment 3. The communication system 10A includes a wireless communication device 100A and a radio wave monitoring apparatus 300A. The wireless communication device 100A is provided separately from the radio wave monitoring apparatus 300A.

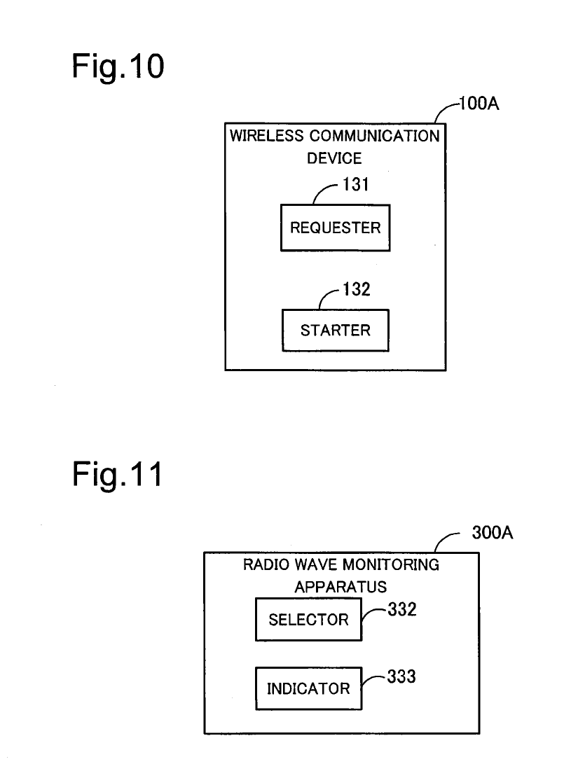

FIG. 10 is a block diagram illustrating the internal configuration of the wireless communication device 100A. The wireless communication device 100A includes a requester 131 and a starter 132. The requester 132 and the starter 133 have similar operations to those of the embodiment described above.

The wireless communication device 100A of the communication system 10A makes wireless communication. The wireless communication made by the wireless communication device 100A is wireless communication employing a standard which requires checking that no specific radio wave has been detected for a predetermined time at one or more channels selected among a plurality of channels, prior to the actual use of the selected channel.

FIG. 11 is a block diagram illustrating the internal configuration of the radio wave monitoring apparatus 300A. The radio wave monitoring apparatus 300A includes a selector 332 and an indicator 333. The selector 332 and the indicator 333 have similar operations to those of the embodiment described above. The radio wave monitoring apparatus 300A of the communication system 10A detects specific radio wave at a plurality of channels.

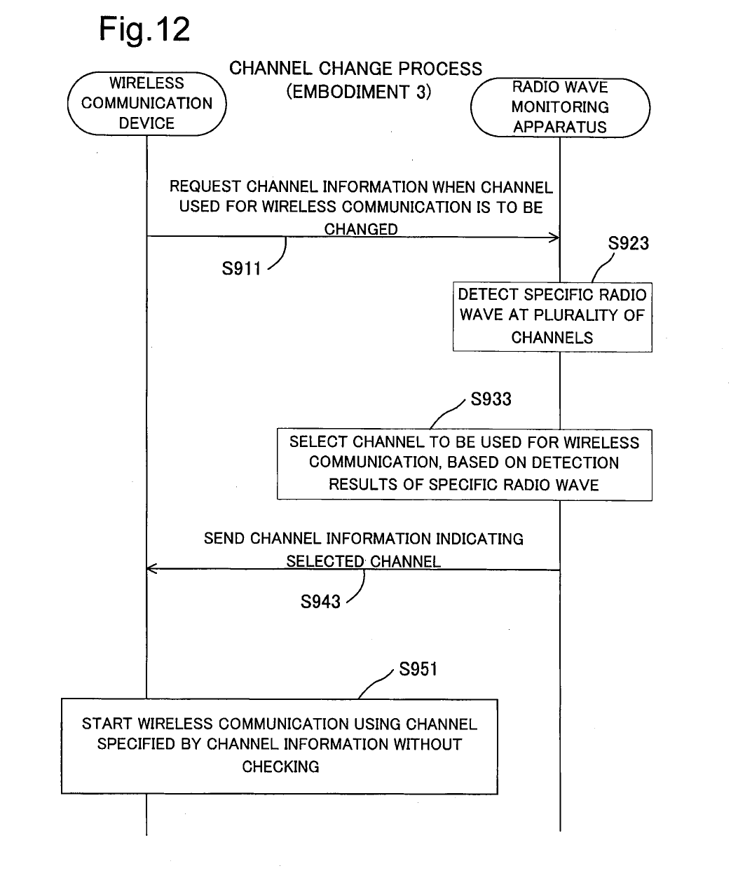

FIG. 12 is a sequence diagram showing a channel change process according to Embodiment 3. When the channel used for wireless communication is to be changed, the wireless communication device 100A request the radio wave monitoring apparatus 300A to provide channel information (step S911).

The radio wave monitoring apparatus 300A detects specific radio wave at a plurality of channels (step S923). The selector 332 of the radio wave monitoring apparatus 300A selects a channel to be used for wireless communication, based on the detection results of the specific radio wave (step S933). The indicator 333 of the radio wave monitoring apparatus 300A sends channel information indicating the selected channel to the wireless communication device 100A (step S943).

After receiving the channel information from the radio wave monitoring apparatus 300A, the wireless communication device 100A starts wireless communication using the channel specified by the channel information without checking prior to the use of the channel (step S951).

Embodiment 3 described above saves the time and labor involved in changing the operation of detecting specific radio wave, thus reducing the cost involved in this change.

The disclosure is not limited to the above embodiments, examples or modifications, but a diversity of variations and modifications may be made to the embodiments without departing from the scope of the disclosure. For example, the technical features of the embodiments, examples or modifications corresponding to the technical features of the respective aspects described in SUMMARY may be replaced or combined appropriately, in order to solve part or all of the problems described above or in order to achieve part or all of the advantageous effects described above. Any of the technical features may be omitted appropriately unless the technical feature is described as essential herein.

At least one of the method of channel bonding and the operation related to radar wave may be changed from the technique described in the embodiment. For example, a technique according to the laws and regulations at the time and at the location of implementation may be employed.

The hardware of the radar wave monitoring apparatus may be designed, such that the radar wave monitoring apparatus has the higher radar wave detection accuracy than that of the wireless communication device. This enhances the reliability of the assumption that “CAC has been performed by the wireless communication device.”

Any channel at which no radar wave has been detected in last 1 minute, in addition to those in last 30 minutes may be added to the selectable options by the selector. Any channel at which the wireless communication device has detected radar wave in last 30 minutes may be excluded.

The radar wave monitoring apparatus may send channel information when it is confirmed that the self device is located adjacent to a wireless communication device, in addition to or in place of identification of the type of radar wave.

Any other condition may be employed as the condition for sending channel information, as long as the technique can make an assumption that “CAC has been performed by the wireless communication device” by using the radar wave monitoring apparatus.

It is not essential that all W52, W53 and W56 are the monitoring target, so that a receiver corresponding to the frequency band excluded from the monitoring target may not be used. This further reduces the cost.

When detecting radar wave, the wireless communication device may select a channel on its own and start CAC. In the course of such operation, the wireless communication device may stop CAC when receiving channel information from the radar wave monitoring apparatus. This allows for an earlier start of CAC in the case of selecting a channel on its own, thus shortening the time of communication interruption.

The number of receivers may be one or any number of not less than 2.

The receiving frequency band of each receiver may be fixed as described in the embodiment, or the receiver may be configured to change the receiving frequency band.

The receiver may be configured to receive only a specific frequency band or may be configured to receive a plurality of frequency bands.

A dip switch or the like may be employed to enable the user's switchover operation, as the configuration of changing the receiving frequency band.

The CPU of the radar wave monitoring apparatus may provide an instruction for allocation of the receiving frequency bands to the respective receivers connected with the radar wave monitoring apparatus. When the number of receivers is insufficient for receiving the entire frequency band covering all the channels, the frequency band having the higher priority may be allocated first.

The radio wave to be monitored is not necessarily radar wave. For example, radio wave emitted from medical equipment may be the monitoring target.

A device making communication with the radar wave monitoring apparatus may be other than the wireless communication device described in the embodiment: for example, a smartphone having the tethering function. Communication with the radar wave monitoring apparatus may be wired or may be wireless.

The number of antennas included in the wireless communication device may be only one or may be three or more.

Part of the functions implemented by the software configuration according to the embodiment may be implemented by hardware configuration. Part of the functions implemented by the hardware configuration according to the embodiment may be implemented by software configuration.

Aspects described below may be employed. According to one aspect, there is provided a communication system. This communication system comprises: a wireless communication device configured to perform wireless communication via a channel selected from a plurality of channels; and a radio wave monitoring apparatus configured to detect a specific radio wave at the plurality of channels, select a channel for the wireless communication based on a result of the detection, and send channel information indicating the selected channel to the wireless communication device, wherein the radio wave monitoring apparatus is provided separately from the wireless communication device, and the wireless communication device comprises: circuitry configured to send a request for the channel information to the radio wave monitoring apparatus when a channel used for the wireless communication is to be changed; and perform the wireless communication using the selected channel indicated by the channel information received from the radio wave monitoring apparatus. The wireless communication device comprises: a requester that requests the channel information to the radio wave monitoring apparatus, when a channel used for the wireless communication is to be changed; and a starter that starts the wireless communication using a channel indicated by the channel information without the checking, after receiving the channel information from the radio wave monitoring apparatus. This aspect saves the time and labor involved in changing the operation of detecting specific radio wave, thus reducing the cost involved in this change. This is because the radio wave monitoring apparatus is provided separately from the wireless communication device. “Starting wireless communication without the checking” described above includes “starting wireless communication after checking that no specific radio wave has been detected at the indicated channel for a shorter time period than the predetermined time.” “The radio wave monitoring apparatus is provided separately from the wireless communication device” means that the radio wave monitoring apparatus and the wireless communication device have different housings.

(2) According to one embodiment of the above aspect, the communication system may include a plurality of the wireless communication devices, and the radio wave monitoring apparatus may send the channel information to a wireless communication device which requests the channel information among the plurality of wireless communication devices. This embodiment reduces the cost of the communication system. This is because there is no need to provide one radio wave monitoring apparatus for each of the wireless communication devices.

(3) According to another embodiment of the above aspect, the radio wave monitoring apparatus sends the channel information to the wireless communication device when an accuracy of detecting the specific radio wave by the radio wave monitoring apparatus is equal to or greater than an accuracy of detecting the specific radio wave by the wireless communication device. This embodiment can avoid transmission of the channel information from the radio wave monitoring apparatus to the wireless communication device, when the detection accuracy of the radio wave monitoring apparatus is lower than that of the wireless communication device.

(4) According to another embodiment of the above aspect, the radio wave monitoring apparatus sends the channel information to the wireless communication device when a first pattern of a first specific wave detected by the radio wave monitoring device is substantially identical to a second pattern of a second specific wave detected by the wireless communication device, and the first specific wave and the second specific wave are detected within a predetermined time of one another. This embodiment increases the possibility that comparison between the detection accuracies is performed adequately.

(5) According to another embodiment of the above aspect, the wireless communication device is configured to perform channel selection autonomously when the channel information is not received from the radio wave monitoring apparatus after the request for the channel information was sent to the radio wave monitoring apparatus. This embodiment enables the wireless communication device to select a channel even in the case of no transmission of the channel information from the radio wave monitoring apparatus. The case of no transmission of the channel information from the radio wave monitoring apparatus may be: for example, the case that no response has been sent from the radio wave monitoring apparatus for a predetermined time or longer; the case that a response representing that the use of the selected channel is not indicated is sent from the radio wave monitoring apparatus; or the case that a communication error or the like is detected.

(6) According to another embodiment of the above aspect, the radio wave monitoring apparatus comprises a plurality of receivers, and the plurality of receivers are configured to each receive the specific radio wave at different channels. This embodiment reduces the cost of the radio wave monitoring apparatus. This is because providing a plurality of receivers which respectively monitor parts of channels is likely to reduce the cost, compared with providing only one receiver which is capable of monitoring all the channels.

(7) According to another embodiment of the above aspect, the plurality of receivers each comprise separate interfaces configured to connect to the radio wave monitoring apparatus. This embodiment enables the plurality of receivers to be individually changed. This reduces the cost required for the change, compared with the case of changing the entire configuration that receives the specific radio wave.

(8) According to another embodiment of the above aspect, the wireless communication device and the radio wave monitoring apparatus are connected by a wired connection. This embodiment enables the wireless communication device to be connected with the radio wave monitoring apparatus without affecting wireless communication and detection of the specific radio wave.

The plurality of structural components included in each aspect of the disclosure described above are not all essential, but some structural components among the plurality of structural components may be appropriately changed, omitted or replaced with other structural components or part of the limitations may be deleted, in order to solve part or all of the problems described above or in order to achieve part or all of the advantageous effects described herein. In order to solve part or all of the problems described above or in order to achieve part or all of the advantageous effects described herein, part or all of the technical features included in one aspect of the disclosure described above may be combined with part or all of the technical features included in another aspect of the disclosure described above to provide still another independent aspect of the disclosure.

For example, one aspect of the disclosure may be implemented as a system including part or all of the two components: a communication device and a monitoring apparatus. This system may include or may not include the monitoring apparatus. This system may include or may not include the communication device. The wireless communication device may be, for example, configured to perform wireless communication via a channel selected from a plurality of channels. The monitoring apparatus may be, for example, configured to detect a specific radio wave at the plurality of channels, select a channel for the wireless communication based on a result of the detection, and send channel information indicating the selected channel to the wireless communication device. The radio wave monitoring apparatus may be, for example, provided separately from the wireless communication device. The wireless communication device may, for example, comprise circuitry. The circuitry may be, for example, configured to send a request for the channel information to the radio wave monitoring apparatus when a channel used for the wireless communication is to be changed; and perform the wireless communication using the selected channel indicated by the channel information received from the radio wave monitoring apparatus. This system may be implemented as, for example, a communication system but may also be implemented as a different system other than the communication system. This aspect can solve at least one of various problems, for example, cost reduction of the system, resource saving, easiness of manufacture and improved usability. Part of all of the technical features involved in the respective embodiments of the communication system described above may also be applicable to this system.

The disclosure may be implemented by any various aspects other than those described above: for example, a radio wave monitoring apparatus alone, a method of selecting a wireless channel, a program configured to implement this method, and a non-transitory storage medium in which this program is stored.

1. A communication system, comprising:
a wireless communication device configured to perform wireless communication via a channel selected from a plurality of channels; and
a radio wave monitoring apparatus configured to detect a specific radio wave at the plurality of channels, select a channel for the wireless communication based on a result of the detection, and send channel information indicating the selected channel to the wireless communication device, wherein
the radio wave monitoring apparatus is provided separately from the wireless communication device, and
the wireless communication device comprises:
circuitry configured to
send a request for the channel information to the radio wave monitoring apparatus when a channel used for the wireless communication is to be changed; and
perform the wireless communication using the selected channel indicated by the channel information received from the radio wave monitoring apparatus.

2. The communication system according to claim 1, further comprising:
a plurality of the wireless communication devices, wherein
the radio wave monitoring apparatus sends the channel information to a wireless communication device which requests the channel information among the plurality of wireless communication devices.

3. The communication system according to claim 1, wherein
the radio wave monitoring apparatus sends the channel information to the wireless communication device when an accuracy of detecting the specific radio wave by the radio wave monitoring apparatus is equal to or greater than an accuracy of detecting the specific radio wave by the wireless communication device.

4. The communication system according to claim 1, wherein
the radio wave monitoring apparatus sends the channel information to the wireless communication device when a first pattern of a first specific wave detected by the radio wave monitoring device is substantially identical to a second pattern of a second specific wave detected by the wireless communication device, and the first specific wave and the second specific wave are detected within a predetermined time of one another.

5. The communication system according to claim 1, wherein
the wireless communication device is configured to perform channel selection autonomously when the channel information is not received from the radio wave monitoring apparatus after the request for the channel information was sent to the radio wave monitoring apparatus.

6. The communication system according to claim 1, wherein
the radio wave monitoring apparatus comprises a plurality of receivers, and
the plurality of receivers are configured to each receive the specific radio wave at different channels.

7. The communication system according to claim 6, wherein
the plurality of receivers each comprise separate interfaces configured to connect to the radio wave monitoring apparatus.

8. The communication system according to claim 1, wherein
the wireless communication device and the radio wave monitoring apparatus are connected by a wired connection.

9. A radio wave monitoring apparatus, comprising:
circuitry configured to
communicate with a wireless communication device which is separately provided from the radio wave monitoring apparatus and is configured to perform wireless communication via a channel selected from a plurality of channels;
detect a specific radio wave at the plurality of channels;
select a channel for the wireless communication in response to a request from the wireless communication device and based on a result of the detection; and
send channel information indicating the selected channel to the wireless communication device.

10. The radio wave monitoring apparatus according to claim 9, wherein the circuitry is further configured to:
communicate with a plurality of the wireless communication devices; and
send the channel information to a wireless communication device that provides the request among the plurality of wireless communication devices.

11. The radio wave monitoring apparatus according to claim 9, wherein the circuitry is further configured to:
send the channel information to the wireless communication device when an accuracy of detecting of the specific radio wave by the radio wave monitoring apparatus is equal to or greater than an accuracy of detecting the specific radio wave by the wireless communication device.

12. The radio wave monitoring apparatus according to claim 9, wherein the circuitry is further configured to:
send the channel information to the wireless communication device when a first pattern of a first specific wave detected by the radio wave monitoring device is substantially identical to a second pattern of a second specific wave detected by the wireless communication device, and the first specific wave and the second specific wave are detected within a predetermined time of one another.

13. The radio wave monitoring apparatus according to claim 9, comprising:
a plurality of receivers configured to receive the specific radio wave at different channels.

14. The radio wave monitoring apparatus according to claim 13, wherein
the plurality of receivers each comprise separate interfaces configured to connect to the radio wave monitoring apparatus.

15. The radio wave monitoring apparatus according to claim 9, wherein
the radio wave monitoring apparatus is connected to the wireless communication device by a wired connection.

16. A method performed by a radio wave monitoring apparatus, the method comprising:
communicating with a wireless communication device which is separately provided from the radio wave monitoring apparatus and is configured to perform wireless communication via a channel selected from a plurality of channels;
detecting a specific radio wave at the plurality of channels;
selecting a channel for the wireless communication in response to a request from the wireless communication device and based on a result of the detecting; and
sending channel information indicating the selected channel to the wireless communication device.
